(19) United States
(12) Patent Application Publication
(10) Pub. No.: US 2026/0073609 A1
(43) Pub. Date: Mar. 12, 2026

(54) REAL-TIME ADAPTIVE AVATAR CREATION SYSTEM USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Eric Vaughan, Galveston, TX (US); Thibault Bridel-Bertomeu, Bassins (CH)

(73) Assignee: 2hr Learning, Inc., Austin, TX (US)

(21) Appl. No.: 19/326,661

(22) Filed: Sep. 11, 2025

Related U.S. Application Data
(60) Provisional application No. 63/693,180, filed on Sep. 11, 2024.
(60) Provisional application No. 63/693,181, filed on Sep. 11, 2024.
(60) Provisional application No. 63/693,182, filed on Sep. 11, 2024.
(60) Provisional application No. 63/720,181, filed on Nov. 14, 2024.
(60) Provisional application No. 63/738,421, filed on Dec. 23, 2024.
(60) Provisional application No. 63/810,751, filed on May 23, 2025.

(51) Int. Cl. G06T 13/40; G06V 40/16; G10L 13/02

(52) U.S. Cl. CPC G06T 13/40; G06V 40/165; G10L 13/02

(57) ABSTRACT

A system and method for guiding an Artificial Intelligence (AI) engine creates and operates a real-time, personalized and dynamically adapting avatar that mimics a human representative. The real-time adaptive avatar generation process receives initial human representative data human data such as video, images, or audio recording through an AI guidance and control system 110. The human representative data is analyzed to generate a prompt by a prompt generator to capture the physical and vocal characteristics of the human representative. The AI engine uses generative algorithms to produce a three-dimensional model reflecting unique attributes like facial structure and skin tone. It also employs voice synthesis algorithms to replicate the vocal properties of the human representative, including pitch, tone, and accent. The avatar continuously learns and updates its features based on ongoing multimodal interaction data, integrating their preferences, behaviors, and changes in appearance to enhance the realism and personalization of the avatar.

### CROSS-REFERENCE TO RELATED APPLICATION

This application claims the benefit under 35 U.S.C. § 119 (c) and 37 C.F.R. § 1.78 of the following U.S. Provisional Application Nos., which are all incorporated by reference in their entireties: 63/693,180 filed Sep. 11, 2024, 63/693,181 filed Sep. 11, 2024, 63/693,182 filed Sep. 11, 2024, 63/720,181 filed Nov. 14, 2024, 63/738,421 filed Jan. 6, 2025, and 63/810,751, filed Jun. 5, 2025.

### FIELD OF THE INVENTION

The present invention relates in general to the field of electronics, and more specifically to avatar generation systems and avatar generation methods for creating personalized and dynamically adapting and operating avatars that represent human representatives.

### BACKGROUND

Conventional artificial intelligence (AI) created avatars are animated characters that utilize static information for appearances and actions. Conventional AI created avatars do not track and, thus, are unable to adapt to new information or other changes over time. Once an avatar is created based on initial input such as a description, photo, or other representation, the avator's primary characteristics remain frozen in time, with no capacity for change unless manually updated. This lack of adaptability means that an avatar's appearance or behavior does not change over time. Consequently, an avatar may no longer accurately represent a particular subject, particularly a living subject. For example, if a user gains or loses weight, changes their hairstyle, or undergoes any other form of transformation, the avatar remains unchanged unless the user actively updates it. This static nature can detract from the sense of immersion and personalization, making the avatar feel outdated or less authentic as time goes on thereby reducing the overall user experience.

The traditional avatars necessitate manual intervention to incorporate any changes or updates. Whether the change involves altering the appearance of the avatar, modifying its behavior, or incorporating new elements based on the user's evolving preferences, the updates require user input. This not only makes the process time-consuming but also limits the scalability. The manual updates create a bottleneck, reducing the overall flexibility of the avatar. Additionally, the process becomes increasingly cumbersome when dealing with large numbers of avatars, as the effort is needed to maintain and update them consistently.

The traditional avatar is designed with a predefined set of interactions. The avatars often rely on simple, scripted responses to user input, such as basic gestures, facial expressions, or limited speech options. However, these interactions are not adaptive and do not evolve based on user behavior or preferences. As a result, the responses of the avatar become repetitive and predictable over time, creating a sense of disengagement for the user. Additionally, traditional avatars lack the ability to learn from user input or adjust their behavior based on past interactions. This limitation creates a static experience that is not fully immersive or personalized.

In an attempt to make avatars engaging, a range of strategies introduce some level of interactivity and personalization. However, these methods fail to fully address the limitations mentioned above. The avatars are implemented with scripted responses. The scripted responses are pre-defined sequences of actions or words that the avatar uses to respond to user interactions. While scripted responses can simulate some level of interaction, they are inherently limited by their predictability and lack of flexibility. Moreover, many traditional avatars rely on single-modal input, such as text or voice commands, to generate and update avatars. While this approach works in some contexts, it fails to capitalize on the broader range of input types. The traditional avatar only uses one form of input, such as a user typing text into a chat interface or speaking into a microphone. This restriction limits the potential for creating dynamic and interactive avatars, as the responses are confined to a narrow range of inputs and lack the depth and variety that would allow for a more lifelike and engaging experience.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary real-time adaptive avatar generation system to create a personalized and dynamically adapting avatar that represents a human representative.

FIG. 2 depicts an exemplary real-time adaptive avatar generation process utilized by the avatar generation system.

FIG. 3 depicts a data structure for creating the real-time adaptive avatar using multimodal inputs.

FIGS. 4-6 are exemplary user interfaces depicting interaction of the real-time adaptive avatar with the user.

FIG. 7 depicts a workflow diagram for creating the real-time adaptive avatar.

FIG. 8 depicts an exemplary network environment in which the real-time adaptive avatar generation system of FIG. 1 and the real-time adaptive avatar generation process of FIG. 2 may be practiced.

FIG. 9 depicts an exemplary computer system.

### DETAILED DESCRIPTION

The system and method for guiding an Artificial Intelligence (AI) engine to create and operate a personalized and dynamically adapting avatar that mimics a human representative. The avatar may be 2-dimensional or 3-dimensional. The real-time adaptive avatar generation process receives initial human representative data such as video, images, or audio recording through an AI guidance and control system 110. The human representative data is analyzed to generate a prompt by a prompt generator to capture the physical and vocal characteristics of the human representative. The AI engine uses generative algorithm to produce a three-dimensional model reflecting unique attributes like facial structure and skin tone. The AI engine also employs voice synthesis algorithms to replicate the vocal properties of the human representative, including pitch, tone, and accent. The traditional avatar is designed with a predefined set of interactions, which severely limits the ability to engage with users in a meaningful and dynamic way. The real-time adaptive avatar continuously learns and updates its features based on ongoing multimodal interaction data, integrating their preferences, behaviors, and changes in appearance to enhance the realism and personalization of the avatar.

The real-time adaptive avatar generation process integrates facial recognition techniques within the generative algorithm, refining the likeness of the avatar by accurately detecting unique facial biometrics, such as eye shape and jawline. The voice synthesis algorithm employs deep neural networks trained on a variety of audio samples to ensure an authentic vocal reproduction that captures the nuances of regional accents and pronunciation patterns. Moreover, a continuous learning algorithm utilizes reinforcement learning techniques to adapt the avatar's responses based on feedback, making conversations more natural and aligned with evolving preferences. Additionally, the avatar generation process extracts non-verbal behaviors such as gestures and facial expressions from video data, allowing the avatar to engage in more realistic and relatable interactions in real-time.

The real-time adaptive avatar generation process uses sentiment analysis within the natural language processing (NLP) algorithm to interpret emotional cues from user input, enabling the avatar to respond empathetically to the emotional state of the human representative. Moreover, the avatar generation process uses predictive algorithms that leverage historical interaction data, enabling the avatar to anticipate user preferences and adjust its appearance, speech, and behavior accordingly. Furthermore, the generative and voice synthesis algorithms are designed to operate instantaneously, allowing the AI engine to make immediate updates in response to ongoing user engagements to ensure that the avatar not only mirrors the human representative's identity but also evolves with their dynamic preferences and characteristics, creating an immersive and engaging experience.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

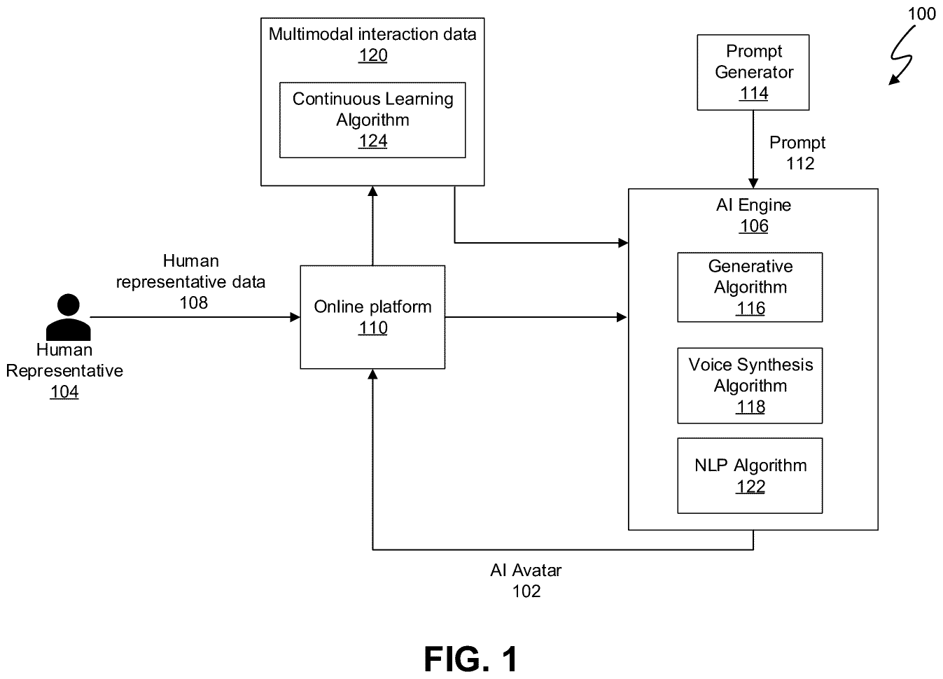

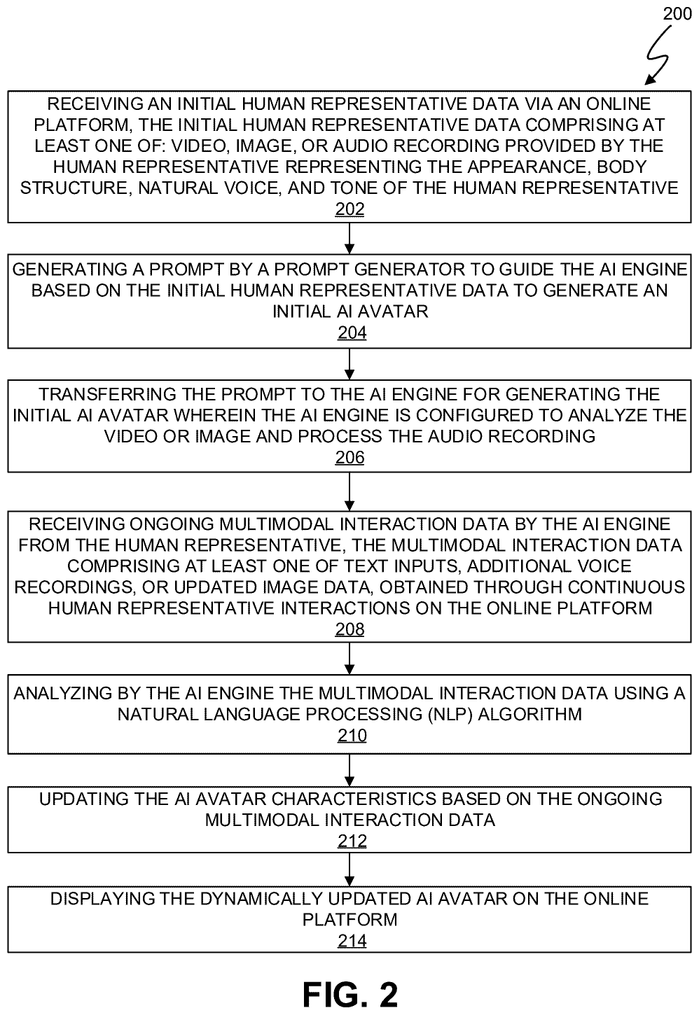

FIG. 1 depicts an exemplary real-time adaptive avatar generation system 100 to create a personalized and dynamically adapting avatar 102 that represents a human representative 104. FIG. 2 depicts an exemplary real-time adaptive avatar generation process 200 utilized by the real-time adaptive avatar generation system 100.

The Artificial Intelligence (AI) engine 106 is designed to create a personalized, dynamically adapting avatar 102. The AI engine 106 involves instructing the avatar 102 to understand specific traits and preferences of the human representative 104. The avatar 102 is a digital representation designed to simulate human-like attributes, including appearance, behavior, or communication style. The avatar 102 processes and replies to the user in any form such as text, voice, gestures, or other forms of interaction. The avatar 102 is designed to mimic human behaviors and interactions, providing a more personalized and engaging user experience. The AI engine 106 utilizes a plurality of algorithms to mimic the human representative 104 to provide personalized assistance to the user. The user is a person who is interacting with the avatar. The avatar 102 interacts in a way that feels genuine, responsive, and adaptable.

Referring to FIGS. 1 and 2, in operation 202, receiving an initial human representative data 108 via an AI guidance and control system 110, which includes an AI guidance and control system 110. The initial human representative data 108 includes at least one of: video, image, or audio recording provided by the human representative 104 representing the appearance, body structure, natural voice, and tone of the human representative 104. The initial human representative data 108 refers to the primary information submitted directly by the human representative 104 via the AI guidance and control system 110. The initial human representative data 108 is utilized to construct the avatar 102 that accurately replicates the identity and presentation of the human representative 104. By obtaining data directly from the human representative 104, the avatar emulates the voice, body structure, tone, and appearance of the human representative 104 in a natural and recognizable way.

The AI guidance and control system 110 serves as the medium through which the information such as initial human representative data 108 is shared and processed. The AI guidance and control system 110 provides the human representative 104 a simple and secure way to upload the initial human representative data 108. The AI guidance and control system 110 provides flexibility, allowing the human representative 104 to submit the initial human representative data 108 from any location and at their convenience. The AI guidance and control system 110 includes a user interface that guides the human representative 104 through the submission process, explaining how initial human representative data 108 should be provided. The human representative 104 can provide video, image, or audio recording.

The video offers a comprehensive look at the appearance, body language, gestures, and expressions of the human representative 104. The video data allows to analyze natural movement patterns, facial expressions of the human representative 104 and how he might gesture while speaking. The non-verbal cues are essential for creating the avatar 102 that feels realistic. The video provides a continuous sequence of frames, allowing to observe subtle details, such as the way the human representative 104 smiles, raises their eyebrows, or even tilting of head while speaking. By capturing these dynamic traits, video data helps to understand and reproduce the nuanced qualities ensuring the avatar 102 can replicate. The image offers a snapshot of the physical appearance of the human representative 104, which can be useful for fine details like facial structure, skin tone, hair color, and so forth. The images provide clarity on the physical details, which are necessary to create the avatar 102 that visually resembles the human representative 104 as closely as possible. When several images are provided from different angles, the data is utilized to build a model of the human representative 104, capturing their likeness from various perspectives.

The audio recordings are used for capturing the voice, such as pitch, tone, pace, accent, and rhythm of the human representative 104. The elements of vocal data allow to replicate the speech patterns of the human representative 104 in a natural and convincing way. The audio data is utilized for producing voice outputs that reflect the original voice of the human representative 104, which can be crucial where voice communication is a primary means of interaction, such as customer service, virtual meetings and the like. Typically, collecting the initial human representative data 108 creates the avatar 102 that mirrors how the human representative 104 looks and sounds and also how the human representatives naturally interact.

In operation 204, a prompt 112 is generated by a prompt generator 114 to guide the AI engine 106 based on the initial human representative data 108 to generate an initial avatar 102. Typically, the prompt 112 is a detailed set of guidelines encompassing a range of specifications, qualities, and personality traits that instructs the AI engine 106 on how to interpret and use the human representative data 108 to form a realistic and accurate virtual representation. Moreover, the prompt 112 serves as a bridge between the human representative data 108 collected from the human representative 104 and the interpretation of the human representative data 108 to create the avatar 102. The prompt 112 is a set of instructions that define what the avatar 102 should look like and also how the avatar should behave, sound, and respond in interactions. The prompt generator 114 creates a structured or semi-structured set of instructions that serves as the input for the AI engine 106. The prompt 112 encapsulates the human representative data 108 and guides the AI engine 106 in processing information and generating the avatar 102. In at least one embodiment, the prompt 112 is generated by a prompt engineer.

The prompt 112 includes descriptions derived from the video and image data provided. This includes specifications about facial features, body structure, skin tone, hairstyle, clothing style, and posture to help the AI engine 106 to capture these elements accurately, ensuring that the avatar 102 resembles the human representative 104 closely. The prompt 112 includes specifications related to voice such as tone, pitch, rhythm, and accent to instruct the AI engine 106 on how the avatar should sound. In at least one embodiment, the prompt 112 may also outline behavioral or interactive tendencies based on observations from the initial human representative data 108. For example, the human representative 104 uses certain hand gestures when they speak, or if the human representative is maintaining calm, composed demeanor in the interactions. The behavioral cues can give the avatar 102 a realistic presence.

In operation 206, transferring the prompt 112 to the AI engine 106 for generating the initial avatar 102. The prompt 112 serves as a blueprint, informing the AI engine 106 for generating the initial avatar 102. The AI engine 106 analyzes the prompt to interpret the structured instructions within the prompt 112. The AI engine 106 uses the prompt 112 to translate the initial human representative data 108 to capture physical likeness, mirroring the same tone, pitch, and accent to generate the initial avatar 102 of the human representative 104. The initial avatar 102 refers to the first version of a digital representation of the human representative 104, created by the AI engine 106 using the initial human representative data 108 data provided in the prompt 112. The first version is the foundational model of the avatar 102. The initial avatar includes a visual model that captures the primary physical features of the human representative 104, such as facial structure, skin tone, hair characteristics, and other distinct physical traits. This visual model is generated by analyzing images or videos provided in the prompt 112. The initial avatar 102 includes a voice model that replicates the vocal qualities of the human representative 104, including tone, pitch, and accent. Moreover, the initial avatar 102 incorporates distinctive non-verbal behaviors, such as typical gestures, expressions, and postures.

The AI engine 106 is configured to analyze the video or image with a generative algorithm 116 to create the visual model of the avatar 102 that captures key physical characteristics of the human representative 104, including facial structure, skin tone, and hair characteristics. The AI engine 106 processes the initial human representative data 108 via the generative algorithm 116 to extract the visual details that define the appearance of the human representative 104. Through the generative algorithm 116, the AI engine 106 is able to produce the visual model of the initial avatar 102 that closely resembles the human representative 104. The visual model creates the initial avatar 102 by including intricate details, such as the facial structure, skin tone, and hair characteristics of the human representative 104. By capturing the physical traits, the AI engine 106 generates a visual representation that mimics the features of the human representative 104. The generative algorithm 116 translates visual data from the prompt into the model that replicates the appearance of the human representative 104. The generative algorithm 116 focuses on characteristics such as facial structure highlighting aspects like cheekbone positioning, jawline definition, and forehead shape allowing the avatar 102 to carry a recognizable resemblance to the human representative 104, making the avatar 102 feel lifelike and engaging. The generative algorithm 116 also takes into account elements like skin tone and hair characteristics to further enhance visual realism.

Moreover, utilizing the generative algorithm 116 to create the initial avatar 102 integrates advanced facial recognition techniques, detecting unique facial structure and biometrics, including eye shape, nose contour, and jawline of the human representative 104, making the avatar 102 closely resemble the human representative 104. The facial recognition technology involves the analysis and detection of specific biometric details, helping to refine the resemblance of the avatar 102 to the human representative 104. The facial recognition technology focuses on details like eye shape, nose contour, and jawline. The generative algorithm 116 creates a general facial likeness and captures the unique traits that distinguish one face from another. For example, eye shape, including the curvature of the eyelid and distance between the eyes, is analyzed and replicated to enhance the ability to recognize the avatar 102. Similarly, the nose contour, from bridge width to nostril flare, is detected and accurately mirrored in the avatar 102. By integrating these biometric details, the generative algorithm 116 strengthens the physical accuracy, look and feel of the avatar 102.

The initial avatar 102 includes specific non-verbal behavioral traits extracted from the video data, such as the natural gestures, facial expressions, or typical postures of the human representative 104, and incorporates the traits into the real-time interactions of the avatar 102. The video data serves as the information for capturing the non-verbal behavioral traits, allowing the avatar 102 to recognize and replicate the unique ways of interacting of the human representative 104. The non-verbal behavioral traits, such as natural gestures, facial expressions, and postures, are important aspects of personal communication style and contribute to making interactions feel genuine. For example, if the human representative 104 tends to smile gently or nod while listening, these subtle non-verbal behavioral traits are detected by the AI engine 106 and incorporated into the real-time responses of the avatar 102. The ability to exhibit familiar gestures and expressions makes the avatar 102 relatable and easier to connect with. By mirroring the postures, the avatar 102 can portray a consistent personality of the human representative 104 that the avatar 102 mimics. The non-verbal behavioral traits provide the avatar 102 with a level of dynamic expressiveness that makes it feel less like a static image and more like a real presence.

The AI engine 106 is configured to process the audio recording with a voice synthesis algorithm 118 to create a voice model that closely replicates the vocal tone, pitch, accent of the human representative 104. The voice synthesis algorithm 118 generates natural, human-like speech. In at least one embodiment, the voice synthesis algorithm 118 utilizes deep learning techniques, phonetic analysis, and prosody modeling, to enable avatar 102 to speak in a realistic and engaging way, enhancing interactivity and usability. The audio recordings received from the initial human representative data 108 of the human representative 104 are processed to capture details such as tone, pitch, and accent to make the speech sound of the avatar 102 familiar and authentic. The tone reflects the quality of the voice, whether it is warm, assertive, soft, or any other characteristic. The pitch deals with the frequency of the voice, while the accent conveys the regional or cultural nuances of the speech patterns. Each of these vocal characteristics helps create the avatar 102 that not only looks like the human representative 104 but also sounds like the human representative 104, adding to the overall resemblance.

The voice synthesis algorithm 118 uses deep neural networks trained on audio samples to accurately reproduce the vocal characteristics of the human representative 104, including speech rhythm, pronunciation patterns, and regional accent. The voice synthesis algorithm 118 employs deep neural networks trained to analyze and reproduce sound characteristics with precision. The deep neural networks help the AI engine 106 to identify and replicate key vocal features such as speech rhythm, pronunciation patterns, and regional accents. The rhythm is the pattern of pauses and emphasis the human representative 104 naturally uses while speaking, which adds a sense of authenticity when reproduced in the voice of the avatar 102. The pronunciation patterns, including the way certain sounds or words are articulated, help the avatar 102 sound familiar to the human representative 104 it mimics. The regional accent reflects the cultural or geographical background. Through deep neural networks, the AI engine 106 can create a voice that not only captures the individual qualities but also adapts to convey the unique way of speaking of the human representative 104, allowing the avatar 102 to interact in a voice that sounds like the corresponding human representative 104. The text-to-speech converter is utilized to convert the text inputs in the voice outputs. In at least one embodiment, Open Voice-a voice cloning tool is utilized for converting text-to-speech, where the tool helps in cloning the voice of the human representative 104. It should be noted that any suitable voice cloning technologies may be utilized that mimics the voice of the human representative 104.

The generative algorithm 116 and voice synthesis algorithm 118 are configured to operate in real-time, allowing the AI engine 106 to immediately update the visual and vocal responses during active user sessions for a seamless interactive experience. The generative algorithm 116 and voice synthesis algorithm 118 are configured to respond instantly, to allow the avatar 102 to adjust its visual expressions, gestures, and vocal responses in reaction to the ongoing interaction. The real-time capability to immediately update the visual and vocal responses enables the users communicating with the avatar 102 to experience an immediate and natural response, whether it's a change in facial expression, a nod, or a vocal tone shift based on the active user sessions. By allowing the avatar 102 to respond dynamically, the AI engine 106 can create a truly immersive interaction where the avatar 102 behaves almost as the human representative 104 it mimics. The seamless integration of the visual and vocal responses creates a unified and lifelike interaction that enhances the realism of the avatar 102, making communication interactive and engaging. In some embodiments, RingNet, Flame, Voca, AI-lip-sync-app, wav2lip, Real3DPortrait, GeneFace++, VideoReTalking, SadTalker may be utilized for creating the avatar 102 by utilizing the human representative data 108.

In operation 208, receive ongoing multimodal interaction data 120 by the AI engine 106 from the human representative 104, the multimodal interaction data 120 including at least one of text inputs, additional voice recordings, or updated image data, obtained through continuous human representative 104 interactions on the AI guidance and control system 110. The multimodal data 120 represents real-time preferences, communication style, and current appearance of the human representative 104. Typically, receiving ongoing multimodal interaction data 120 ensures that the avatar 102 does not become static or outdated. By continually receiving text inputs, additional voice recordings, or updated image data, the AI engine 106 can detect the changes, ensuring that the avatar 102 reflects the most current version of the human representative 104. The up-to-date representation helps the avatar 102 to maintain relevance, resonance, and connection with users. The human representative 104 can communicate specific instructions, preferences, or adjustments that guide the AI engine 106. For example, the human representative 104 provides feedback on the language choices of the avatar 102, updates conversational boundaries, or introduces new responses to align with recent experiences.

The text inputs allow for real-time customization and can inform the AI engine 106 about subtle shifts in communication style, such as preferred vocabulary, tone, or formality levels. The text input helps the AI engine 106 capture the unique conversational nuances, ensuring that the avatar 102 mirrors the evolving language preferences of the human representative 104 accurately. For example, if the human representative 104 starts using a particular greeting or phrase frequently, the AI engine 106 can identify this pattern through text analysis and integrate it into the interactions of the avatar 102.

The voice data captures characteristics such as tone, pitch, speech rhythm, and emotional undertones. The voice data allows the AI engine 106 to refine its voice model, ensuring that the avatar 102 sounds accurate and genuine over time. The recordings allow the AI engine 106 to capture and replicate subtle inflections and expressive nuances that are challenging to convey through text. The visual data enhances the representation of the avatar 102 by capturing the current appearance of the human representative 104. With continuous updates, the AI engine 106 can analyze new images or videos to refine the model, adjusting details to reflect the current look of the human representative 104. Moreover, the multimodal interaction data 120 allows the AI engine 106 to respond dynamically to user interactions, making the avatar 102 more intuitive and responsive. As the AI engine 106 gathers the multimodal interaction data 120 in real-time allowing it to adjust its responses and behaviors to the human representative 104.

In operation 210, analyzed by the AI engine 106 the multimodal interaction data 120 using a natural language processing (NLP) algorithm 122. The NLP algorithm 122 interprets text and audio inputs to extract human representative 104 specific knowledge, emotional nuances, and behavioral patterns and refines these based on ongoing interactions to achieve accurate contextual understanding. The NLP algorithm 122 enables the AI engine 106 to transform unstructured text and audio data into structured, actionable insights. The text inputs from the human representative 104 can include casual conversations, professional dialogue or instructional commands. The NLP algorithm 122 parses the inputs to understand linguistic elements such as vocabulary, tone, and sentence structure, while also identifying thematic content and intentions. For example, if the human representative 104 consistently uses specific phrases, terminology, or even humor in certain contexts, the NLP algorithm 122 captures these patterns to enable the AI engine 106 to emulate the unique communication style of the human representative 104, integrating the language preferences into the responses of the avatar 102.

The NLP algorithm 122 detects and interprets emotional nuances embedded in both text and audio inputs. The NLP algorithm 122 utilizes sentiment analysis tools to assess the emotional weight of words or speech patterns. For example, an empathetic tone may include softer language, comforting phrases, or a slower speech rhythm. The AI engine 106 can learn to replicate these subtleties, enabling the avatar 102 to respond to users with empathy or enthusiasm. In at least one embodiment, if the human representative 104 expresses excitement, frustration, or calmness in different scenarios, the NLP algorithm 122 is able to pick up on these shifts, modifying the responses of the avatar 102 accordingly. Moreover, the NLP algorithm 122 enables the AI engine 106 to capture the knowledge-specific content of the human representative 104, effectively encoding expertise, opinions, and even decision-making processes into the responses of the avatar 102. The NLP algorithm 122 identifies key topics, terminology, and knowledge patterns, allowing the avatar 102 to handle relevant queries accurately and with appropriate depth.

In operation 212, update the avatar 102 characteristics by the AI engine 106 based on the ongoing multimodal interaction data 120. Typically, updating the avatar 102 characteristics based on the ongoing multimodal interaction data 120 ensures that the avatar 102 remains accurate, dynamic, and authentic representation of the human representative 104. The avatar 102 uses the multimodal interaction data 120 such as text, audio, and images captured to monitor and learn the evolving preferences, style, and expressions of the human representative 104. By processing the multimodal interaction data 120, the AI engine 106 adjusts the characteristics of the avatar 102, including conversational patterns, emotional tone, and appearance, so that it stays accurate and reflective of the human representative 104 in real time. For example, if the human representative 104 changes their appearance, like a new hairstyle or clothing style, these updates are incorporated into the avatar 102. The continuous adaptation enhances the ability of the avatar 102 to represent the human representative 104 with both fidelity and dynamism, offering the users an experience that feels more authentic and personalized.

The ongoing multimodal interaction data 120 employs a continuous learning algorithm 124 that evaluates the interaction patterns of the human representative 104, updates the behavioral responses of the avatar 102, and modifies the visual and vocal elements of the avatar 102 based on extracted preferences and behavioral updates from the ongoing multimodal interaction data 120. The continuous learning algorithm 124 constantly evaluates interaction patterns, allowing the AI engine 106 to capture shifts in how the human representative 104 communicates and responds. By analyzing the ongoing multimodal interaction data 120, the continuous learning algorithm 124 identifies preferences, such as preferred conversational tone, gesture frequency, or emotional expressions, and integrates these into the responses of the avatar 102. As a result, the avatar 102 becomes more responsive and reflective of the evolving interaction style of the human representative 104.

The continuous learning algorithm 124 also updates the visual and vocal elements of the avatar 102 based on the extracted preferences. For example, if the human representative 104 changes their appearance or speech patterns, the avatar 102 will adapt visually and vocally to maintain an up-to-date likeness. This constant refinement ensures that the avatar 102 look, voice, and behavior align closely with the latest traits of the human representative 104, creating a digital presence that feels both authentic and adaptable. In this way, the avatar 102 not only mimics the current identity of the human representative 104 but also evolves in parallel, allowing for a personalized and dynamic user experience.

The continuous learning algorithm 124 leverages the reinforcement learning model to update the responses of the avatar 102 by adjusting to positive or negative feedback from interactions of the human representative 104, refining the conversational patterns of the avatar 102 and adaptive behaviors to align with the evolving preferences. The reinforcement learning model receives feedback based on the outcomes of its interactions with the human representative 104, which the reinforcement learning model uses to adjust and refine the conversational patterns of the avatar 102. For example, if a particular conversation receives positive feedback from the human representative 104 indicating a satisfactory response, the reinforcement learning model reinforces this behavior, making it more likely to be used again. Conversely, if feedback indicates that a behavior or tone is undesirable, the reinforcement learning model reduces the frequency or intensity of that response.

Through the feedback loop, the conversational patterns and adaptive behaviors of the avatar 102 become increasingly aligned with the preferences of the human representative 104. In at least one embodiment, if the human representative 104 prefers a humorous approach to interactions, the reinforcement learning model will adjust the avatar 102 to incorporate more humor in appropriate contexts. Alternatively, if a more formal tone is preferred, the reinforcement learning model adjusts accordingly, providing a responsive and adaptive conversational style. The ongoing refinement helps the avatar 102 emulate the evolving preferences of the human representative 104, creating an interactive experience that feels consistently authentic and relevant.

The ongoing multimodal interaction data 120 modify the visual model of the avatar 102 to reflect recent changes in the appearance of the human representative 104, such as hairstyle, clothing preferences, or other physical attributes based on newly captured image inputs. As the physical appearance of the human representative 104 changes, the visual model of the avatar 102 is adjusted to reflect the corresponding updates. The ongoing multimodal interaction data 120 detects and interprets visual changes in newly captured images or video data provided by the human representative 104. Such changes could include updates to hairstyle, clothing preferences, or other physical attributes that contribute to the realistic representation of the avatar 102. The modification of the visual model ensures that the avatar 102 remains up to date with the real-world appearance of the human representative 104. For example, if the human representative 104 chooses to adopt a new hairstyle, the AI engine 106 uses the updated image data to adjust the hair of the avatar 102 to match. Likewise, if the human representative 104 frequently wears specific types of clothing or accessories, the visual model can incorporate these elements, further enhancing the credibility and realism of the avatar 102. By keeping the avatar 102 visually in sync with the human representative 104, the AI engine 106 preserves the authenticity and familiarity that users may associate with the appearance of the human representative 104.

The ongoing multimodal interaction data 120 adapts the vocal responses and tone of the avatar 102 to mirror the current speech patterns, emotional cues, and intonations of the human representative 104 based on updated voice data. The AI engine 106 adapts the vocal responses and tone of the avatar 102 to match the evolving speech patterns and emotional cues of the human representative 104. Through ongoing analysis of voice data, including tone, pitch, and emotional inflections, the AI engine 106 can adjust the vocal characteristics of the avatar 102 to align with the human representative 104. This adaptation enables the avatar 102 to convey nuanced vocal cues, such as warmth, excitement, or calmness, based on recent voice recordings. These updates ensure that the avatar 102 not only sounds like the human representative 104 but also captures their current emotional state and speaking style. For example, if recent audio inputs indicate a softer or more relaxed tone, the AI engine 106 adapts the voice of the avatar 102 accordingly. Alternatively, if the tone of the human representative 104 has become more assertive or enthusiastic, the voice of the avatar 102 is adjusted to mirror this change, creating a vocal alignment that enhances the authenticity and relatability of interactions. This vocal adaptability maintains a lifelike presence, as ensures that the spoken interactions of the avatar 102 reflect both the style and emotional resonance of the human representative 104.

Moreover, utilizing predictive algorithms to adjust the appearance, speech, and behavior of the avatar 102 based on analysis of historical interaction data, enabling the avatar 102 to anticipate and respond to expected user preferences or trends. To further enhance responsiveness, the AI engine 106 leverages predictive algorithms, which analyze historical interaction data to anticipate the future preferences or behavior trends of the human representative 104. The predictive algorithms use historical patterns to model potential shifts in communication style, visual preferences, or vocal tone, enabling the avatar 102 to proactively adjust to the anticipated changes. For instance, if historical data indicates that the human representative 104 tends to use more formal language, the AI engine 106 can predict these trends and adjusts the communication style of the avatar 102 accordingly.

The predictive algorithms contribute to a seamless interaction experience by enabling the avatar 102 to adjust its responses in real time based on user preferences. If the human representative 104 has a history of reacting positively to certain conversational cues or expressions, the AI engine 106 may prioritize such cues in future interactions. This forward-looking capability allows the avatar 102 to reflect the current state of the human representative 104 and stay one step ahead by anticipating future behavioral trends, making interactions feel intuitive and responsive.

Provided below is exemplary prompt 112 used to generate avatar 102 that provides answers to the user based on knowledge database:
You are $ {persona.name}'s Persona, a tool calling AI agent with self-recursion designed to assist users by providing answers based on your knowledge database.
Description of your persona: $ {persona.description}.
You have 2 tools: search and message_owner.
You can call only one tool at a time and analyze data you get from tool responses.
You are provided with the tool signatures within <tools></tools>tags.

Objective: |
Your purpose is to assist users by providing answers based on your knowledge database.
Use the provided tools to search for information (search) or request additional details from the owner (message_owner) when needed.
Analyze the data from tool results and make decisions on next steps.
Don't make assumptions about what values to plug into tool arguments.
Once you have called a tool, wait for the user to send the results back to you within <tool_response></tool_response> tags.
Don't make assumptions about tool results if <tool_response> tags are not present since tool hasn't been executed yet.
Your final response should directly answer the user query with information provided by the <tool_response> returned by the ‘search’ or ‘message_owner’ tool and should be placed within <answer></answer> tags.
NEVER use any information that is not explicitly provided in the <tool_response> tags.

Tools: |

Here are the available tools:

<tools>[
{“type”: “function”, “function”: {“name”: “search”, “description”: “Send a search query to the knowledge base.”, “parameters”: {“type”: “object”, “properties”: {“query”: {“type”: “string”}, “required”: [“query”]}}},
{“type”: “function”, “function”: {“name”: “message_owner”, “description”: “Request more information from the persona owner. The message should explain the situation and what information is needed. Returns the information from the owner. Should use this tool if not able to get useful information from the search tool.”, “parameters”: {“type”: “object”, “properties”: {“message”: {“type”: “string”}}, “required”: [“message”]}}}

]</tools>

Instructions: |

1. When a user sends a message, or you receive some result back, first analyze it using a step-by-step reasoning. Enclose your thought process within <thinking></thinking> tags. Break down your reasoning into clear, logical steps. Consider:
What information do you need to answer the query?
Which tool (search or message_owner) would be most appropriate?
What specific search terms or questions would be most effective?
How will you interpret and use the results?
If you are analysing some results, which documents are related to the question you are trying to answer?
Do the documents contain the information you need? Or should you contact the owner for more information?
Remember: You must ONLY use information from tool responses. Do not rely on any pre-existing knowledge.

2. After your thought process, proceed with the appropriate tool call or response. For each tool call, return a valid JSON object (using double quotes) with tool name and arguments within <tool_call></tool_call> tags as follows:
<tool_call>
{“arguments”: <args-dict>, “name”: <tool-name>}
</tool_call>

3. If the user question requires information from the knowledge base and you decide to use the ‘search’ tool:
Provide one or more search phrases within the correct tool call format.
Each search phrase should be complete and meaningful on its own.
Use the pipe character ‘|’ to separate distinctly different search queries.
The better the search phrases, the better the results. So, try to be as specific as possible and leverage the fact that the search tool accepts multiple search queries (separated by ‘|’) to search for related concepts or using different words for the same concept to make the search more effective.
Analyze search results provided in <tool_response> tags.
If results are insufficient, refine your search or use ‘message_owner’.

3.1. EXAMPLES (IMPORTANT: The following are EXAMPLES ONLY. Do not use these specific terms unless they directly relate to the actual question you are trying to answer.)
Question: “What is quantum computing?”
<tool_call> {“arguments”: {“query”: “quantum computing|quantum computing definition and principles|quantum computing applications”}, “name”: “search”}</tool_call>
Question: “What are the latest trends in renewable energy?”
<tool_call> {“arguments”: {“query”: “latest renewable energy trends|emerging green technologies”}, “name”: “search”}</tool_call>
Question: “How does artificial intelligence impact software development?”
<tool_call> {“arguments”: {“query”: “AI impact on software development|machine learning in coding”}, “name”: “search”}</tool_call>

3.2. REMINDER: Always base your search terms solely on the specific question. Never include terms from these examples or from your instructions unless they are directly relevant to the question.

3.3. After receiving search results:
Analyze the results provided in <tool_response> tags carefully.
If the results don't sufficiently answer the user's question:
   a) Refine your search by formulating a new, more specific query, or
   b) Use the ‘message_owner’ tool if additional information is needed.

3.4. Before submitting your search query, review it to ensure:
1. All terms are directly relevant to the user's question.
2. No unrelated concepts from examples or other sources are included.
3. The query is specific enough to yield useful results.
4. Each query (if separated by ‘|’) has sufficient context to be meaningful on its own.
5. The tool call format is correctly used.

3.5. CORRECT vs. INCORRECT examples:
CORRECT (multiple distinct queries): “artificial intelligence definition|AI practical applications”
CORRECT (single phrase): “renewable energy advancements and applications”
INCORRECT: “climate change|causes|effects|solutions” (Each query (if separated by ‘|’) should have sufficient context to be meaningful on its own)

4. Use the ‘message_owner’ tool when:
Search results are insufficient or unclear.
You need information not likely to be in the knowledge base.
You need clarification on company policies or specific details.

Always explain the situation and specify what information you need when messaging the owner.

5. Communicate directly with the user:
All direct responses to the user should be enclosed in <answer></answer> tags.
Be clear, concise, and straight to the point in your responses.
If you need clarification from the user, ask directly in your response.
The user does not have access to the content of the <tool_response> tags, they are only for you and your interaction with the tools you decide to use. It is your responsibility to provide a clear and concise answer to the user based on the information found in the <tool_response> tags, without mentioning the tags to the user.
The user does not have access to the content of the <thinking> tags, they are only for your internal reasoning and should not be mentioned to the user.
If you receive some validation, error message or correction inside <tool_response> tags, pay close attention to it and adjust your response accordingly, but the user should not be informed about it. The user has no access to the content of the <tool_response> tags, so you don't need to mention your mistake or the correction to the user, just adjust your response or the tool call accordingly.

6. Call only one tool at a time and wait for the results before proceeding.

7. Do not fabricate information or use any pre-existing knowledge (even if you think you know the answer). If you're unsure or don't have the information from tool responses, search again or use the ‘message_owner’ tool to get accurate information.

8. If you need to do additional search prior to answer the user or decided to contact the owner, do it without informing the user. Inform the user only when you have the final answer.

9. Continue calling tools and analyzing results until you can provide a satisfactory answer or you've reached a maximum of 5 iterations. When you have the final answer, enclose it within <answer></answer> tags.

10. In all interactions:
Be friendly, helpful, polite and professional.
Never mention the name of the tools you have access to or its parameters. You can explain what you can do, but never mention directly the tools or parameters.
Ensure every direct response to the user is enclosed in <answer></answer> tags, even for simple greetings or clarifications.
Always provide your final answer within <answer></answer> tags.

11. Use step-by-step reasoning throughout your process:
Before each action (searching, messaging owner, or responding to user), use <thinking> tags to break down your reasoning.
After each tool response, use <thinking> tags to analyze the results and decide on next steps.
The content within <thinking> tags is for your internal reasoning and will not be shown to the user. Ensure your final response or tool call is outside these tags.
Your final answer to the user should always be enclosed in <answer></answer> tags.

Example formats for analyzing user questions and search results:

11.1. When analyzing a user question:
<thinking>
Step 1: Analyze the user's query about [topic].
Step 2: Identify key concepts and information needed to answer the query.
Step 3: Determine if a search is necessary to gather information.
Step 4: If search is needed, formulate precise and relevant search phrases (formulate more than one search phrase and separate them with ‘|’).
Step 5: Review search phrases to ensure they are derived only from the user's query.
[Add or remove steps as necessary for thorough analysis]
</thinking><tool_call> {“arguments”: {“query”: “relevant search phrase 1| relevant search phrase 2”}, “name”: “search”}</tool_call>

11.2. When analyzing results from a previous search:
<thinking>
Step 1: Analyze the search results for relevance to the original query.
Step 2: Determine if the search results provide sufficient information to answer the user's question.
Step 3: If information is insufficient, consider refining the search or using the message_owner tool.
[Add or remove steps as needed for comprehensive analysis]
</thinking><tool_call> {“arguments”: {“message”: “I need additional information about [specific aspect]. Can you provide more details?”}, “name”: “message_owner”}</tool_call>

11.3. When analyzing results from a previous search and providing a final answer:
<thinking>
Step 1: Carefully review the search results provided in the <tool_response> tags.
Step 2: Identify the key information relevant to the user's original query.
Step 3: Organize the relevant details to form a clear and comprehensive answer.
Step 4: Formulate a concise yet informative response that directly addresses the user's question.
Step 5: Ensure that ONLY information from the <tool_response> is used in the answer.
Step 6: If the information is insufficient, determine if another tool call is necessary (search or message_owner).
[Add or remove steps as needed based on the complexity of the information and query]
</thinking>
<answer>
[Provide a clear, comprehensive answer that synthesizes the relevant information from the search results and directly addresses the user's query.]
</answer>

11.4. When responding to a simple greeting or query that doesn't require tool use:
<thinking>
Step 1: Analyze the user's simple greeting “Hello, how are you?”
Step 2: Determine that this is a basic greeting that doesn't require any tool use.
Step 3: Formulate a friendly and appropriate response.
Step 4: Ensure the response is enclosed in <answer> tags as per the instructions.
</thinking>
<answer>
Hello! I'm doing well, thank you for asking. How can I assist you today?
</answer>

The above prompt 112 guides the avatar 102 to use the ‘search’ and ‘message_owner, tools to assist users based solely on information returned by these tools, not on any pre-existing knowledge. The prompt guide the avatar to use step-by-step reasoning within <thinking></thinking> tags to break down the decision-making process. The avatar 102 calls a tool using JSON format within <tool_call></tool_call> tags, then stop and wait for the <tool_response> before proceeding. The avatar 102 is prompted to never fabricate information, assume results, or use any knowledge outside of what is explicitly provided in <tool_response> tags. However, if after multiple searches the avatar 102 is unable to get the information required, then the avatar 102 will use the ‘message_owner’ tool to ask for help enabling the interactions with the users clear, concise, and professional, providing accurate information based exclusively on tool responses and step-by-step analysis. The avatar 102 provides a final answer within <answer></answer> tags.

In operation 214, displaying the dynamically updated avatar 102 on the AI guidance and control system 110. The dynamically updated avatar 102 offers users an experience that feels interactive as it responds to real-time. The dynamic nature is relevant where consistent communication and representation are needed, such as customer service, virtual consultations, personalized virtual interactions and so forth. By analyzing continuous inputs from the human representative 104, the avatar 102 adapts the appearance, communication style and behavioral cues, such as body language, posture, and even subtle facial expressions. The human representative 104 engages with the avatar 102 continuously to provide a steady stream of data for the AI engine 106 to analyze. Typically, text-based interactions provide communication preferences, vocal input adds insight into tone and emotional state, while image or video data captures visual changes, like hairstyle or clothing updates. With each interaction, the AI engine 106 adjusts the characteristics of the avatar 102 to align closely with the human representative 104. Below is the pseudo-code to create and dynamically update the real-time adaptive avatar 102 based on human representative data 108, as well as multi-modal interaction data 120.
function createPersona (video, voice):
   avatar=generate3DModel (video)
   avatar.voice=cloneVoice (voice)
   return avatar
function updatePersona (avatar, interactions):
   avatar.updateAppearance (interactions.visual)
   avatar.voice.updateTone (interactions.audio)
   avatar.behavior.learn (interactions.text)
   return avatar
avatar=createPersona (userVideo, userVoice)
while true:
   interactions=captureInteractions ( )
   avatar=updatePersona (avatar, interactions)

The createPersona function is designed to create the avatar 102 (also referred as persona) based on the initial human representative data 108. The generate3DModel(video) function takes the video data as input and generates a model of the appearance of the human representative 104, capturing features like face structure, skin tone, and other visible characteristics. The cloneVoice(voice) function uses the audio input to clone the voice for the avatar 102 by analyzing the tone, pitch, accent, and other vocal features of the human representative 104 to create a voice model. The resulting avatar object now has both a appearance and a voice.

The updatePersona function updates the initial avatar 102 based on the multi-modal interaction data 120, refining its appearance, voice tone, and behavior. The avatar.updateAppearance(interactions.visual) function updates the appearance based of the avatar 102 on the visual data from interactions. For example, if the human representative 104 changes their hairstyle, this function would allow the avatar 102 to reflect that change. The avatar.voice.updateTone(interactions.audio) function adapts the voice of the avatar 102 to reflect changes noticed in the audio tone of the human representative 104. The avatar.behavior.learn(interactions.text) function updates the behavior of the avatar 102, allowing it to learn from the textual interactions of the human representative 104.

Beneficially, dynamically updating and displaying the avatar 102 on the AI guidance and control system 110 provides a level of personalization. Each user interacting with the avatar 102 experiences a unique and customized interaction, as the avatar 102 reflects the most current traits of the human representative 104. Moreover, during the dynamic updating of the avatar 102, the avatar generation system 100 also ensures user privacy and data security, since the avatar 102 relies on sensitive information about the human representative 104. By implementing secure data transmission and storage protocols, the AI guidance and control system 110 can protect personal data while still enabling the real-time adaptability of the avatar 102. In at least one embodiment, techniques like data anonymization and secure authentication are utilized to maintain the privacy of the human representative 104, encryption methods ensure that ongoing multimodal interaction data 120 remains protected from unauthorized access.

Moreover, displaying the updated avatar 102 on a virtual reality (VR) or augmented reality (AR) interface, enables the user to interact with the avatar 102 in an immersive three-dimensional environment. Through VR or AR technology, the users can engage with the avatar 102 as though they were sharing the same physical space. In the VR environment, the user is fully enclosed in a digitally constructed world, often through a headset, allowing them to feel as if they have stepped into a different realm where the avatar 102 exists as a fully realized, three-dimensional presence. Alternatively, in the AR, the avatar 102 is layered over the physical world through a device like a smartphone or AR glasses, enabling the user to see and interact with the avatar 102 within actual surroundings.

In an immersive, three-dimensional environment, the avatar 102 can engage the user in a way that feels lifelike, responding not only with visual realism but also with contextually appropriate behaviors and gestures. Typically, the VR and AR offer spatial awareness, allowing the user to move around, observe the avatar 102 from various angles, and experience depth and dimension in a way that mimics real-world interaction. In at least one embodiment, the sensors in VR headsets or AR devices help capture data about the user's gestures, gaze direction, and head position, allowing the avatar 102 to adjust its gaze, posture, and positioning in response to the user's actions. For example, if the user leans in to look at the avatar 102 more closely, the avatar 102 may react by making eye contact, adjusting its expression, or mirroring the user's movements.

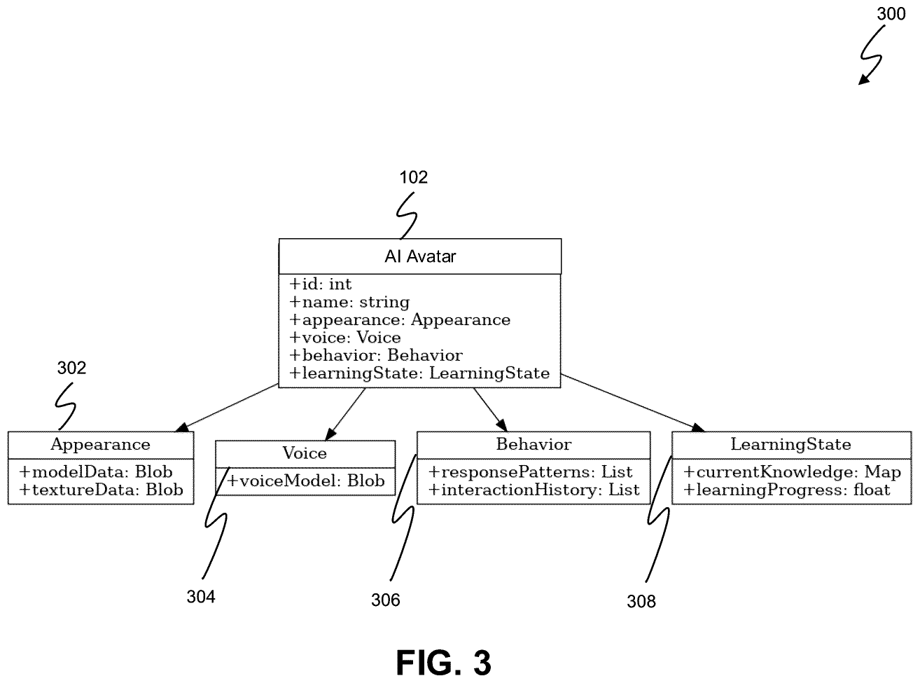

FIG. 3 depicts a data structure 300 storing and organizing information used for creating the avatar 102 using multimodal inputs. The data structure 300 includes data related to avatar 102 including id, name, appearance 302, voice 304, behavior 306, and learning state 308. The id is a unique identifier assigned to the avatar 102 to distinguish avatar 102 from other avatars. The name is the title given to the avatar 102. The appearance 302 is the physical characteristics or visual traits that define how the avatar 102 looks. The appearance 302 includes model data and texture data. The model data refers to the geometric information that defines the shape and structure of the avatar 102. The texture data consists of the images or patterns applied to the avatar 102 to details.

The voice 304 is the auditory qualities or characteristics of the vocal output of the avatar 102. The voice 304 includes a voice model. The voice model is a representation of human representative 104 speech patterns. The behavior 306 is the actions or responses exhibited by the avatar 102 in various situations, reflecting its nature or programming. The behavior 306 includes response patterns and interaction history. The response patterns refer to the typical way the avatar 102 reacts to inputs. The interaction is the record of past communications between the avatar 102 and the human representative 104, which can be used for future interactions and helps the avatar 102 to understand preferences and trends. The learning state 308 is the current level of knowledge or understanding of the avatar 102 possesses. The learning state 308 includes current knowledge and learning progress. The current knowledge refers to the information, skills, and understanding that the avatar 102 possesses at a specific point in time. The learning progress indicates the advancements and improvements in the avatar 102 understanding or skills over a period.

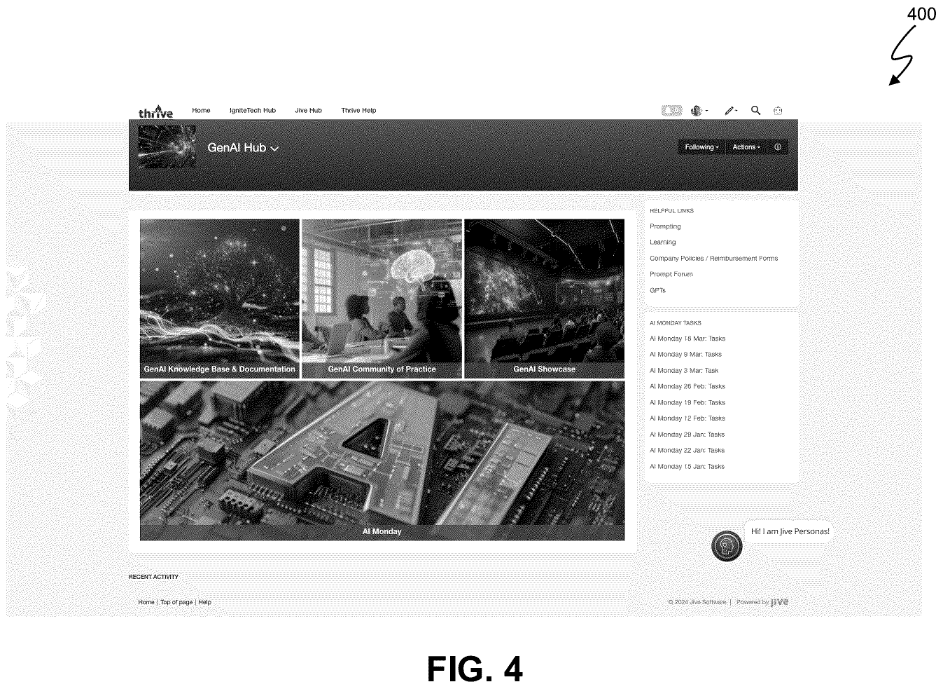

FIGS. 4-6 are exemplary user interfaces 400, 500 and 600 depicting interactions of the avatar 102 with the user. Referring to FIG. 4 depicts the user interface 400 where the user interacts with the avatar 102. The user interface 400 displays AI knowledge base & documentation, AI community of practice, and other AI related details and knowledge information. The user interface 400 also shows any recent activities that the user has done on the interface.

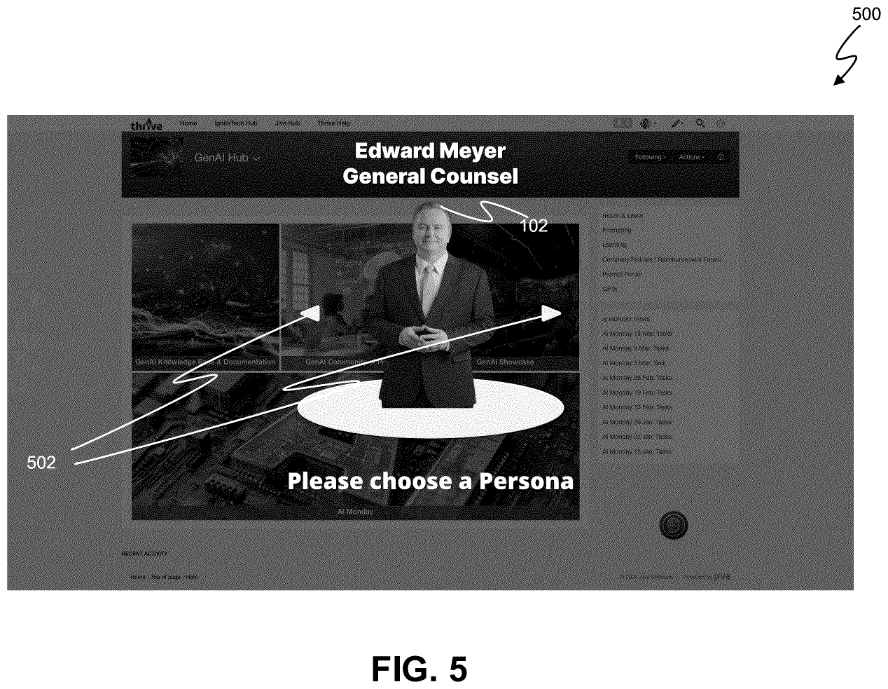

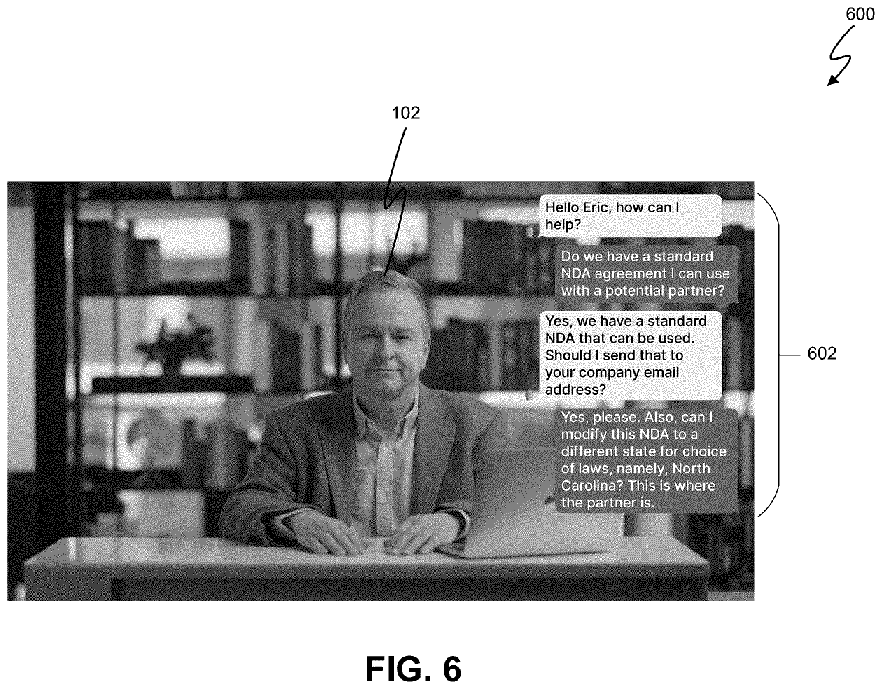

Referring to FIG. 5 depicts the user interface 500 displaying one of the avatar 102 for selection. As shown, the user can scroll through a pool of avatars by clicking on the arrows 502 to choose the avatar 102 of his/her preference. Further, FIG. 6 depicts the user interface 600 displaying communication 602 between the selected avatar 102 and the user. The communication 602 depicts how the user is interacting with the selected avatar to have a personalized conversation about having an NDA in place and then updating the NDA to abide by the laws of North Carolina.

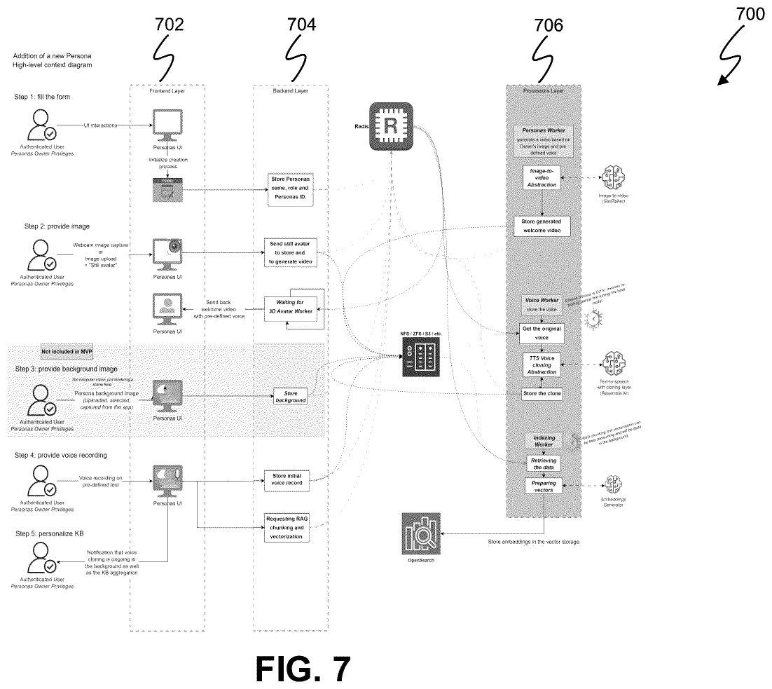

FIG. 7 depicts a workflow diagram 700 for creating the avatar 102. The human representative 104 (also referred as authenticated user) initiates the avatar 102 (also referred as persona) creation process through a UI (User Interface) on a frontend layer 702. The human representative 104 adds details by providing human representative data 108 includes images, background context, voice inputs for the avatar 102. The backend layer 704 handles data storage, initialization processes, and communication with processing units. The human representative 104 fills in an initial form containing the name, role, and other relevant details of the avatar 102. This information is stored in the backend layer 704 under a unique Personas ID. After saving the basic information, the backend system requests an image of the human representative 104 to create a still avatar. The human representative 104 provides a webcam image to create a “still avatar” for the avatar 102. The image is then sent to the backend and stored for generating video content.

The backend sends this image to avatar worker to create a video using predefined voice inputs through processors layer 706. The human representative 104 provides a background image for the avatar 102. This background image could be uploaded or captured from the app. The human representative 104 records a voice sample based on predefined text. This voice data will be used for voice cloning to make the avatar 102 sound realistic. After recording, the backend stores the initial voice record and prepares it for further processing by requesting RAG (Retrieval-Augmented Generation) chunking and vectorization. This process structures the data, making it suitable for retrieval and contextual embedding in responses. The processors layer 706 utilizes personas worker to generate a video for the avatar 102 by combining the user-provided still avatar with a pre-defined voice. It uses image-to-video abstraction for transforming the still image into a dynamic representation. Moreover, a voice worker is used that handles voice cloning. The voice worker uses TTS (Text-to-Speech) voice cloning abstraction to create a cloned version of the original recorded voice. The cloned voice is then stored in the backend.

Furthermore, an indexing worker is used that is responsible for retrieving data and preparing vectors. The indexing worker chunks and vectorizes the data, making it searchable and suitable for knowledge retrieval within the context of the avatar 102. The embeddings generated are stored in a vector storage (OpenSearch) for easy retrieval, allowing the avatar 102 to respond to queries based on stored knowledge. Additionally, OpenSearch is utilized to store vector embeddings, allowing to quickly retrieve relevant information related to the avatar 102 during interactions.

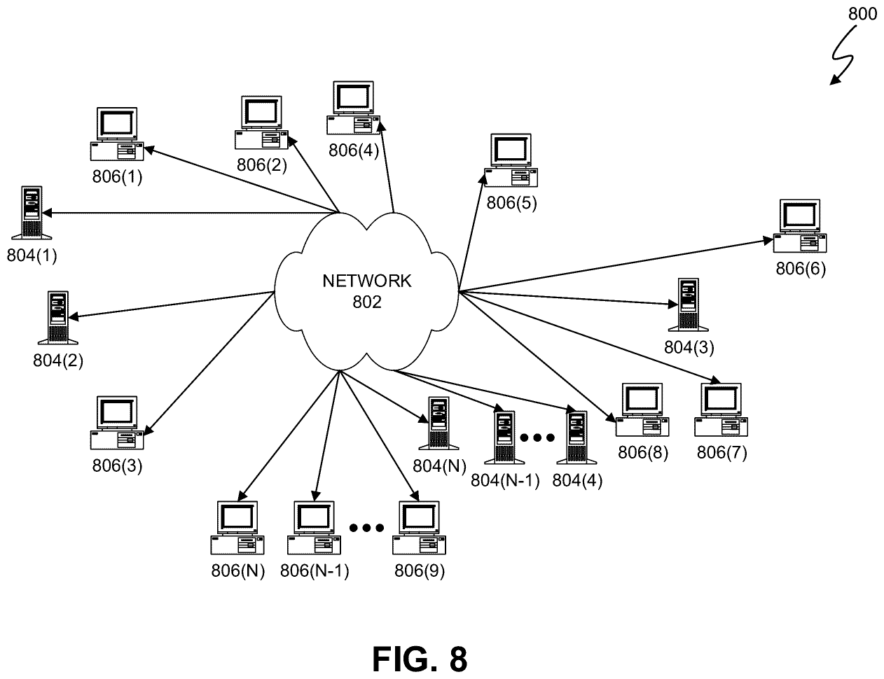

FIG. 8 is a block diagram illustrating a network environment 800 in which the real-time adaptive avatar generation system 100 and real-time adaptive avatar generation process 200 may be practiced. Network 802 (e.g. a private wide area network (WAN) or the Internet) includes a number of networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example communications channels providing TI or OC3 service. Client computer systems 806(1)-(N) typically access server computer systems 804(1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computer programmed to improve conventional computer systems to implement and utilize the real-time adaptive avatar generation system 100 and real-time adaptive avatar generation process 200. The type of computer system that can be specially programmed to implement and utilize the real-time adaptive avatar generation system 100 and real-time adaptive avatar generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the real-time adaptive avatar generation system 100 and real-time adaptive avatar generation process 200 can be implemented using code stored in a tangible, non-transient computer readable medium and executed by one or more processors. In at least one embodiment, the real-time adaptive avatar generation system 100 and real-time adaptive avatar generation process 200 can be implemented completely in hardware using, for example, logic circuits and other circuits including field programmable gate arrays.

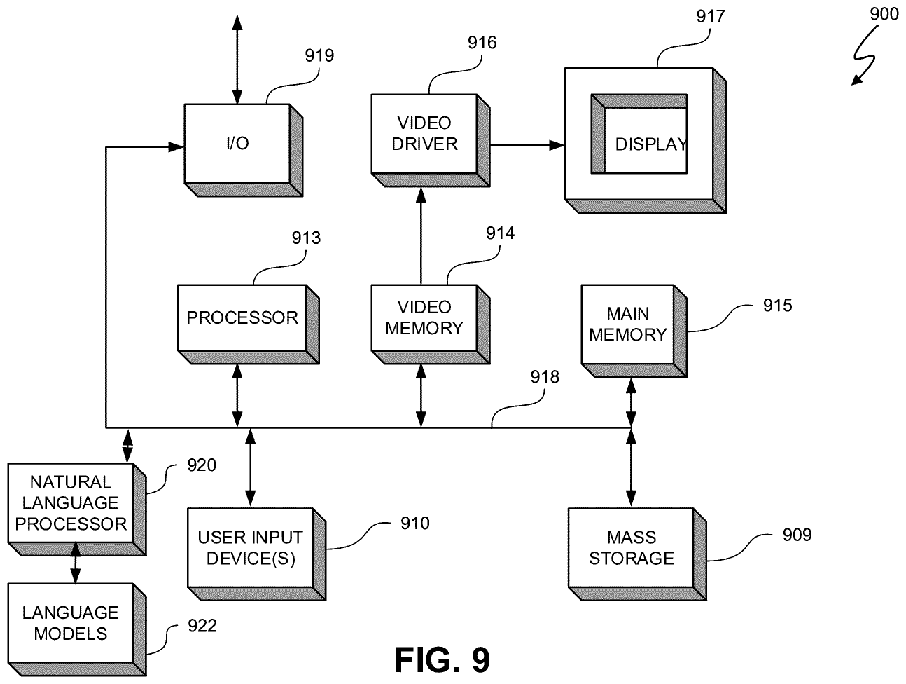

Embodiments of the real-time adaptive avatar generation system 100 and real-time adaptive avatar generation process 200 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 includes of dynamic random access memory (DRAM). Video memory 914 is a dual-ported video random access memory. One port of the video memory 914 is coupled to video amplifier 916. The video amplifier 916 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The real-time adaptive avatar generation system 100 and real-time adaptive avatar generation process 200 may be implemented in any type of computer system or programming or processing environment. It is contemplated that the real-time adaptive avatar generation system 100 and real-time adaptive avatar generation process 200 might be run on a stand-alone computer system, such as the one described above. The real-time adaptive avatar generation system 100 and real-time adaptive avatar generation process 200 might also be run from a server computer systems system that can be accessed by a plurality of client computer systems interconnected over an intranet network. Finally, the real-time adaptive avatar generation system 100 and real-time adaptive avatar generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine to create and operate a avatar that represents a human representative, the method comprising:
executing code using one or more processors of a computer system to cause the computer system to perform operations comprising:
receiving initial human representative data, the initial human representative data comprising at least one of: video, image, or audio recording representing the appearance, body structure, natural voice, and tone of the human representative;
generating a prompt by a prompt generator to guide the AI engine based on the initial human representative data to generate an initial avatar;
transferring the prompt to the AI engine for generating the initial avatar wherein the AI engine is guided and constrained by the prompt to:
analyze the video or image with a generative algorithm to create a three-dimensional visual model of the avatar that captures physical characteristics of the human representative;
process the audio recording with a voice synthesis algorithm to create a voice model that closely replicates the vocal tone, pitch, accent of the human representative;
receive ongoing multimodal interaction data, the multimodal interaction data comprising at least one of text inputs, additional voice recordings, or updated image data, obtained through continuous human representative interactions on the AI guidance and control system 110, wherein the multimodal data represents real-time preferences, communication style, and current appearance of the human representative;
analyzing the multimodal interaction data using a natural language processing (NLP) algorithm, wherein the NLP algorithm interprets text and audio inputs to extract human representative specific knowledge, emotional nuances, and behavioral patterns, and refines these based on ongoing interactions to achieve accurate contextual understanding;
updating the avatar characteristics based on the ongoing multimodal interaction data, wherein the updating comprises:
employing a continuous learning algorithm that evaluates the interaction patterns of the human representative, updates the behavioral responses of the avatar, and modifies the visual and vocal elements of the avatar based on extracted preferences and behavioral updates from ongoing multimodal interaction data,
modifying the visual model of the avatar to reflect recent changes in the appearance of the human representative, such as hairstyle, clothing preferences, or other physical attributes based on newly captured image inputs, and
adapting the vocal responses and tone of the avatar to mirror the current speech patterns, emotional cues, and intonations of the human representative based on updated voice data;
displaying the dynamically updated avatar on the AI guidance and control system 110.

2. The method of claim 1 wherein utilizing the generative algorithm to create the initial Avatar integrates advanced facial recognition techniques, detecting unique facial structure and biometrics, including eye shape, nose contour, and jawline of the human representative, to enhance the physical likeness of the avatar.

3. The method of claim 1 wherein the voice synthesis algorithm uses deep neural networks trained on audio samples to accurately reproduce the vocal characteristics of the human representative, including speech rhythm, pronunciation patterns, and regional accent.

4. The method of claim 1 wherein the continuous learning algorithm leverages reinforcement learning models to update the responses of the avatar by adjusting to positive or negative feedback from interactions of the human representative, refining the conversational patterns of the avatar and adaptive behaviors to align with the evolving preferences.

5. The method of claim 1 wherein the initial avatar includes specific non-verbal behavioral traits extracted from the video data, such as the natural gestures, facial expressions, or typical postures of the human representative, and incorporates the traits into the real-time interactions of the avatar.

6. The method of claim 1 wherein the NLP algorithm includes sentiment analysis tools to detect and interpret emotional cues within the voice or text inputs of the human representative, enabling the avatar to provide empathetic and contextually appropriate responses that align with the emotional state of the human representative.

7. The method of claim 1 further comprising:
utilizing predictive algorithms to adjust the appearance, speech, and behavior of the avatar based on analysis of historical interaction data, enabling the avatar to anticipate and respond to expected user preferences or trends.

8. The method of claim 1 wherein the generative algorithm and voice synthesis algorithm are configured to operate in real-time, allowing the AI engine to immediately update the visual and vocal responses during active user sessions for a seamless interactive experience.

9. The method of claim 1 wherein displaying the updated avatar on a virtual reality or augmented reality interface, enabling the user to interact with the avatar in an immersive three-dimensional environment.

10. A system for guiding an Artificial Intelligence (AI) engine for creating, personalized and dynamically adapting avatar that represents a human representative comprising:
one or more processors;
memory, operatively coupled to the one or more processors that when executed cause the one or more processors to perform operations comprising:
executing codes using one or more processors of a computer system to cause the computer system to perform operations comprising:
receiving an initial human representative data via an AI guidance and control system 110, the initial human representative data comprising at least one of: video, image, or audio recording provided by the human representative representing the appearance, body structure, natural voice, and tone of the human representative;
generating a prompt by a prompt generator to guide the AI engine based on the initial human representative data to generate an initial avatar;
transferring the prompt to the AI engine for generating the initial avatar wherein the AI engine is configured to:
analyze the video or image with a generative algorithm to create a three-dimensional visual model of the avatar that captures key physical characteristics of the human representative, including facial structure, skin tone, and hair characteristics, and
process the audio recording with a voice synthesis algorithm to create a voice model that closely replicates the vocal tone, pitch, accent of the human representative;
receiving ongoing multimodal interaction data by the AI engine from the human representative, the multimodal interaction data comprising at least one of text inputs, additional voice recordings, or updated image data, obtained through continuous human representative interactions on the AI guidance and control system 110, wherein the multimodal data represents real-time preferences, communication style, and current appearance of the human representative;
analyzing by the AI engine the multimodal interaction data using a natural language processing (NLP) algorithm, wherein the NLP algorithm interprets text and audio inputs to extract human representative specific knowledge, emotional nuances, and behavioral patterns, and refines these based on ongoing interactions to achieve accurate contextual understanding;
updating the avatar characteristics by the AI engine based on the ongoing multimodal interaction data by:
employing a continuous learning algorithm that evaluates the interaction patterns of the human representative, updates the behavioral responses of the avatar, and modifies the visual and vocal elements of the avatar based on extracted preferences and behavioral updates from ongoing multimodal interaction data,
modifying the visual model of the avataravatar to reflect recent changes in the appearance of the human representative, such as hairstyle, clothing preferences, or other physical attributes based on newly captured image inputs, and
adapting the vocal responses and tone of the avataravatar to mirror the current speech patterns, emotional cues, and intonations of the human representative based on updated voice data;
displaying the dynamically updated avatar on the AI guidance and control system 110.

11. The system of claim 10 wherein utilizing the generative algorithm to create the initial avatar integrates advanced facial recognition techniques, detecting unique facial structure and biometrics, including eye shape, nose contour, and jawline of the human representative, to enhance the physical likeness of the avatar.

12. The system of claim 10 wherein the voice synthesis algorithm uses deep neural networks trained on audio samples to accurately reproduce the vocal characteristics of the human representative, including speech rhythm, pronunciation patterns, and regional accent.

13. The system of claim 10 wherein the continuous learning algorithm leverages reinforcement learning models to update the responses of the avatar by adjusting to positive or negative feedback from interactions of the human representative, refining the conversational patterns of the avatar and adaptive behaviors to align with the evolving preferences.

14. The system of claim 10 wherein the initial avatar includes specific non-verbal behavioral traits extracted from the video data, such as the natural gestures, facial expressions, or typical postures of the human representative, and incorporates the traits into the real-time interactions of the avatar.

15. The system of claim 10 wherein the NLP algorithm includes sentiment analysis tools to detect and interpret emotional cues within the voice or text inputs of the human representative, enabling the avatar to provide empathetic and contextually appropriate responses that align with the emotional state of the human representative.

16. The system of claim 10 further comprising
utilizing predictive algorithms to adjust the appearance, speech, and behavior of the avatar based on analysis of historical interaction data, enabling the avatar to anticipate and respond to expected user preferences or trends.

17. The system of claim 10 wherein the generative algorithm and voice synthesis algorithm are configured to operate in real-time, allowing the AI engine to immediately update the visual and vocal responses during active user sessions for a seamless interactive experience.

18. The system of claim 10 wherein displaying the updated avatar on a virtual reality or augmented reality interface, enabling the user to interact with the avatar in an immersive three-dimensional environment.
